(19) United States
(12) Patent Application Publication
(10) Pub. No.: US 2021/0155361 A1
(43) Pub. Date: May 27, 2021

(54) CONTAINER FOR RECEIVING LIQUIDS

(71) Applicant: E-proPLAST GmbH, Schmalkalden (DE)

(72) Inventor: Ruediger LOEHL, Schmalkalden (DE)

(21) Appl. No.: 16/950,392

(22) Filed: Nov. 17, 2020

(30) Foreign Application Priority Data
Nov. 21, 2019 (DE) 10 2019 131 426.7

(51) Int. Cl. B65D 1/42; B65D 1/02

(52) U.S. Cl. CPC B65D 1/42; B65D 1/0207; B65D 2501/0081; B65D 2501/0018; B65D 1/0223

(57) ABSTRACT

The container is used for receiving liquids and is formed substantially from a thermoplastic material. A container wall is provided at least in certain regions with a rib-like structure. The container wall has an oval profile in a horizontal cross-sectional area. The container is provided with two mutually opposite curved longitudinal sides and two mutually opposite curved transverse sides. In the region of at least one of the longitudinal sides, the rib-like structure is configured in such a way that it has, at least in certain regions, a reinforcing rib of closed encircling shape.

### CROSS-REFERENCE TO RELATED APPLICATIONS

The present application claims priority of DE 10 2019 131 426.7, filed Nov. 21, 2019, the priority of this application is hereby claimed, and this application is incorporated herein by reference.

### BACKGROUND OF THE INVENTION

The invention relates to a container for receiving liquids, which is formed substantially from a thermoplastic material and in the case of which a container wall is provided at least in certain regions with a rib-like structure and wherein the container wall has an oval profile in a horizontal cross-sectional area such that the container has two mutually opposite curved longitudinal sides and two mutually opposite curved transverse sides.

Containers for receiving liquids are used in particular in the food industry in very different embodiments. The containers are typically configured in the form of bottles and have a closure. The containers are filled with fruit juices, sauces and syrups, for example.

### SUMMARY OF THE INVENTION

In the case of food products, these need to be filled in a hot state in order to kill, or at least reduce, germs or bacteria or yeasts. Hot filling of this kind frequently takes place in a temperature range of approximately 85° C. to 87° C.

PET (polyethylene terephthalate) is frequently used as thermoplastic material for containers of this kind. Containers composed of such a material are not readily suitable for hot filling, since the material, which has been produced previously by a blow moulding operation, is prone to shrinkage. In order to support a hot filling capacity, during the blow moulding, the container can be subjected to a specific crystallization in order to increase the material stability; as an alternative or in addition, it is also possible for the container wall to be provided with specific profilings.

A further problem in the hot filling of liquids is that the filled-in liquid and possibly air located in a head space of the container are subjected to a reduction in volume during the cooling. This contraction can also lead to the container being subjected, without suitable measures, to deformation.

A known measure for preventing or reducing deformation of this kind consists in arranging more-stable regions and less-stable regions in the region of side walls of the container. In this way, the deformation can be concentrated onto the less-stable regions, with the result that the basic form of the container is not adversely affected. The less-stable regions are configured here in the form of so-called mirror surfaces, which, upon contraction of the filling material, are pulled in the direction of the bottle interior. By contrast, the stable rib-like regions are not substantially deformed, with the result that the basic structure of the container remains unchanged.

Further measures for increasing the stability of the container are frequently realized in the region of a base of the container. Here, too, specific rib structures are already known. In the base region, it has proven to be particularly critical that, during the filling of the hot filling material, the hot filling material initially strikes directly on the base.

Due to the production method, as a result of blow moulding with the so-called heat-set technology, the bottle base has the lowest crystallinity in the bottle body after the blow moulding operation. A rib structure of the base is therefore imperative.

As an alternative to the measures explained above for improving the structural stability of the container, it is also already known to additionally meter liquid nitrogen into the already filled container prior to a closing operation and to thereby build up an additional internal pressure after the closing operation.

However, the use of a technique of this kind is currently limited to substantially round container forms, since otherwise the internal pressure could lead to deformation of the container.

The technique described above for generating an overpressure cannot be used in particular in the case of oval bottles composed of plastic. In particular, in many applications, special closures are provided which would not be able to withstand an internal overpressure.

The possibility already mentioned in principle above of using reinforcing ribs in the region of walls of the container is also subject to various limitations. By way of example, certain rib structures may for their part again promote deformation of the container. In addition, the use of known rib-like structures limits possibilities for attaching labels to the containers.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a side view of a container according to the invention, looking at a longitudinal side of the container,

FIG. 2 shows a side view according to viewing direction II-II in FIG. 1 and

FIG. 3 shows a viewing direction onto a base of the container according to viewing direction III in FIG. 1,

FIG. 4 shows an enlarged illustration for illustrating the geometry of the bottle wall in the region of the ribbing.

### DETAILED DESCRIPTION OF THE INVENTION

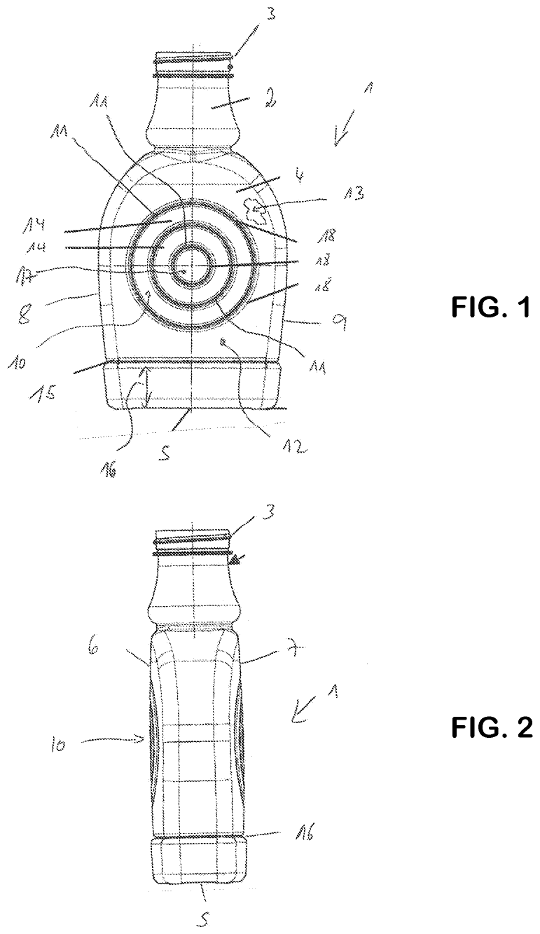

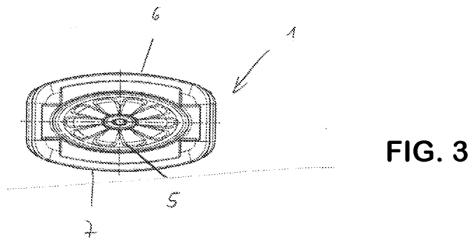

According to the embodiment in FIG. 1 to FIG. 3, a container (1) is of bottle-like configuration and is composed of a plastic. Polyethylene terephthalate is preferably intended to be used. However, it is also possible to use other plastics, for example polypropylene.

The container (1) has a neck (2) with a closure thread (3). The container (1) has a side wall (4) and a base (5). The oval shape, in a horizontal cross-sectional area, of the container (1) is achieved in that use is made both of two mutually opposite, outwardly curved longitudinal sides (6, 7) and of two likewise substantially mutually opposite and outwardly curved transverse sides (8, 9). Here, in the already mentioned horizontal cross-sectional area, the longitudinal sides (6, 7) have a greater length than the transverse sides (8, 9).

A rib-like structure (10) is arranged in the region of at least one of the longitudinal sides (6, 7). The rib-like structure (10) comprises at least one circular reinforcing rib (11). According to the illustrated exemplary embodiment, the reinforcing rib (11) is configured in the form of a groove-like recess which extends from a wall surface (12) of the container (1) into an interior (13) of the container (1).

According to the illustrated exemplary embodiment, spacer regions (14) extend in each case between two circular reinforcing ribs (11). The spacer regions (14) are of substantially planar configuration, wherein the characterization “planar” here also encompasses the curved shape defined by the outer contour of the container (1).

After the container (1) has been filled, provision is made for a closure (not illustrated) to be screwed on in the region of the closure thread (3). A label can be attached in an outer region of the container (1).

As a result of the circular reinforcing ribs (11) which are preferably arranged concentrically, forces caused by a volume contraction of the filling material are uniformly introduced into the wall of the container (1).

To further increase the stability of the container (1), in a lower region in the vertical direction, provision is made for a peripheral recess (16) to be arranged at a spacing (15) above the base (5).

The arrangement of the plurality of circular reinforcing ribs (11), which are illustrated in the exemplary embodiment, in the illustrated concentric arrangement imparts membrane-like is properties to the wall of the container (1) in the relevant region. In this way, the body of the container (1) can be uniformly deformed. According to a customary method sequence when performing the hot filling, the body of the container (1) widens to some extent briefly after the filling and then contracts again during the following cooling process. The circular concentric profiles of the reinforcing ribs (11) promote a uniform conduct of this operation and prevent a weakening of the body of the container (1).

The dimensioning of the circular reinforcing ribs (11) makes it possible to influence the stiffness of the container (1). In particular, the widths, the depths and also the inclinations and curvatures of the reinforcing ribs (11) can be varied. It is likewise possible to form a center (17) which is enclosed by the reinforcing ribs (11) and has a lower wall thickness than the wall region outside of the reinforcing ribs (11).

To increase the adherence of a possibly used label, it is possible for one or more concentric recesses (18) to be arranged below the relevant label.

In a cooling phase subsequent to the hot filling of the container (1), a negative pressure is generated as a result of the volume contractions of the filling material within the container (1). In this way, the atmospheric external pressure exerts a force on the container (1) and the force can promote a deformation of the container in the direction of its interior (13). The concentric arrangement of the reinforcing ribs (11) produces the circular center (17), and also semi-circular surfaces. These surfaces have a lower stability in relation to the circular reinforcing ribs (11), such that the deformation is introduced in a targeted manner in the region of the less-stable regions.

In addition, the concentric reinforcing ribs (11) make it possible to reduce a bulge of the label field towards the outside as a result of a suitable selection of the respective depths.

The spacer regions (14), which likewise run in a substantially circular ring-shaped manner, provide further labile zones in the region of the wall of the container (1), said zones, during the performance of the cooling operation, being able to be deformed in a targeted manner in the direction of the interior (13) of the container (1) and thereby compensating the reduction in volume of the filling material.

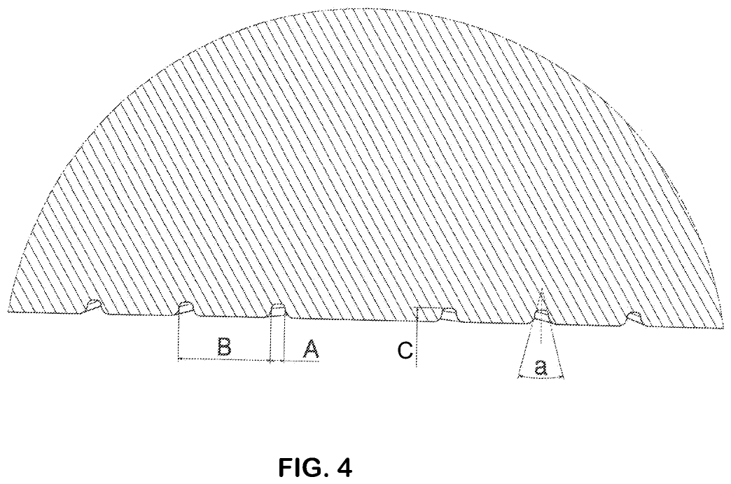

FIG. 4 shows an enlarged illustration of the geometry of the reinforcing ribs (11). To achieve the desired stability, the reinforcing ribs (11) have a specific width, a specific depth, and also defined profiles of inclinations and walls. A spacing of the reinforcing ribs (11) from one another is also important for the stability.

The side walls of the reinforcing ribs (11) have an inclination at an angle a. The angle a typically lies in a range of 20° to 60°. The ratio of a groove depth C to a groove width A typically lies in a range of 0.5 to 2.0.

The ratio of a groove spacing B to the groove width A typically lies in a range of 6.0 to 8.0.

With regard to the aforementioned dimensioning indications, it should be taken into account that different regions of the reinforcing ribs (11) are typically led over into one another by rounded profiles. The aforementioned value ranges can easily be varied in dependence on the concrete dimensioning of the corresponding rounded profiles.

The term encircling shape of the reinforcing ribs (11) which is used repeatedly above means in particular a circuit in the area spanned by the side wall (4) of the container (1). The encircling shape leads to a profile, which is closed in this area, of the reinforcing rib (11). In particular in a configuration as a recess, the reinforcing rib (11) is thus open towards the outside in spite of the closed encircling shape. In a configuration as a protruding ribbing, a shape which is open in the direction of the interior (13) of the container (1) is similarly also encompassed.

While specific embodiments of the invention have been shown and described in detail to illustrate the inventive principles, it will be understood that the invention may be embodied otherwise without departing from such principles.

I claim:

1. A container for receiving liquids, which is formed substantially from a thermoplastic material, the container comprising a container wall having, at least in certain regions, a rib-like structure, wherein the container wall has an oval profile in a horizontal cross-sectional area so that the container has two mutually opposite curved longitudinal sides and two mutually opposite curved transverse sides, wherein, in a region of at least one of the longitudinal sides, the rib-like structure has at least one reinforcing rib with a closed encircling shape.

2. The container according to claim 1, wherein the thermoplastic material is PET.

3. The container according to claim 1, wherein the rib-like structure is arranged in the region of both of the two longitudinal sides.

4. The container according to claim 1, wherein the at least one reinforcing rib is a groove-like recess proceeding from a wall surface.

5. The container according to claim 1, wherein the container is of a bottle configuration.

6. The container according to claim 1, wherein the container is configured so as to be able to be hot-filled.

7. The container according to claim 1, wherein the rib-like structure has two reinforcing ribs with flat spacer regions arranged in each case between the two reinforcing ribs.

8. The container according to claim 1, wherein the rib-like structure has a flat center, wherein the flat center is surrounded concentrically by the at least one reinforcing rib.

9. The container according to claim 8, wherein the flat center is surrounded by a plurality of the reinforcing ribs.

10. The container according to claim 9, wherein the reinforcing ribs run in a substantially circular manner.

11. The container according to claim 9, wherein the reinforcing ribs run in a substantially oval manner.

12. The container according to claim 9, wherein the reinforcing ribs run in a substantially rhomboid manner.

13. The container according to claim 9, wherein the reinforcing ribs run in a substantially rectangular manner with rounded corner regions.

14. The container according to claim 1, wherein three reinforcing ribs are arranged in the region of the side wall.

15. The container according to claim 10, wherein three reinforcing ribs are concentrically running circular reinforcing ribs.
